(19) United States
(12) Patent Application Publication
(10) Pub. No.: US 2023/0017484 A1
(43) Pub. Date: Jan. 19, 2023

(54) AUTOMATED CIRCUIT DESIGN VALIDATION

(71) Applicant: Battelle Memorial Institute, Columbus, OH (US)

(72) Inventors: Adam KIMURA, Lewis Center, OH (US); James SCHAFFRANEK, Westerville, OH (US); Alexander MANG, Columbus, OH (US)

(21) Appl. No.: 17/854,029

(22) Filed: Jun. 30, 2022

Related U.S. Application Data
(60) Provisional application No. 63/217,041, filed on Jun. 30, 2021.

(51) Int. Cl. G06F 30/398; G06F 30/392

(52) U.S. Cl. CPC G06F 30/398; G06F 30/392; G06F 2111/20

(57) ABSTRACT

The present disclosure provides a circuit design validation system. In one embodiment, the system includes polygon extraction circuitry to determine, based on layer images of a fabricated integrated circuit (IC), a plurality of polygons associated with a layer of the fabricated IC; and cell pattern matching circuitry to search the polygons defined within a layer image of the fabricated IC to determine a match between a cell template of a standard cell library and the plurality of polygons defined within the layer image of the fabricated IC.

This application claims the benefit of U.S. Provisional Application No. 63/217,041, filed Jun. 30, 2021, which is hereby incorporated by reference in its entirety.

### STATEMENT OF GOVERNMENT INTEREST

This invention was made with government support under FA8650-20-F-1134, Task Order 3, awarded by The Air Force Research Lab. The government has certain rights in the invention.

### TECHNICAL FIELD

The present disclosure relates to automated circuit design validation.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates a circuit design validation system according to several embodiments of the present disclosure; and

FIG. 2 illustrates operations of search area size and shape determination circuitry according to one example embodiment of the present disclosure; and

FIG. 3 illustrates additional example operations of the search area size and shape determination circuitry according to one embodiment of the present disclosure; and

FIG. 4 illustrates example operations of cell pattern matching circuitry according to one embodiment of the present disclosure; and

FIG. 5 illustrates a flowchart of operations for circuit design validation according to one embodiment of the present disclosure.

Although the following Detailed Description will proceed with reference being made to illustrative embodiments, many alternatives, modifications, and variations thereof will be apparent to those skilled in the art.

### DETAILED DESCRIPTION

This disclosure provides novel automated circuit design validation techniques. In embodiments described herein, after integrated circuit (IC) fabrication of a circuit design, the IC may be delayered and imaged using conventional and/or proprietary delayering and imaging techniques to enable as-fabricated validation of the IC. Polygon shapes within the images are extracted to form vectorized polygon shapes. Using the original standard cell library associated with the design of the IC, pattern matching circuitry is used to match cell patterns from the extracted features to the standard cell library. Thus, the present disclosure provides automated techniques of identifying cells in the layer images using pattern matching techniques based on the standard cell library of the original circuit design. Once cells are identified and placed within the layered images, the present disclosure also provides for generating a netlist of the as-fabricated circuit design, which may then be compared to the original circuit design netlist to discover errors in fabrication, errors in design, etc., thus enabling automated validation of the fabricated IC. The automated techniques according to the present disclosure substantially reduce conventional time-consuming visual (human) inspection of identifying cells within the layer images and validating fabricated ICs. Also, the automated pattern matching provided herein greatly increases the accuracy of the cell placement, whereas previously the cells could be misaligned when placed thus impacting the accuracy of the as-fabricated (recovered) netlist.

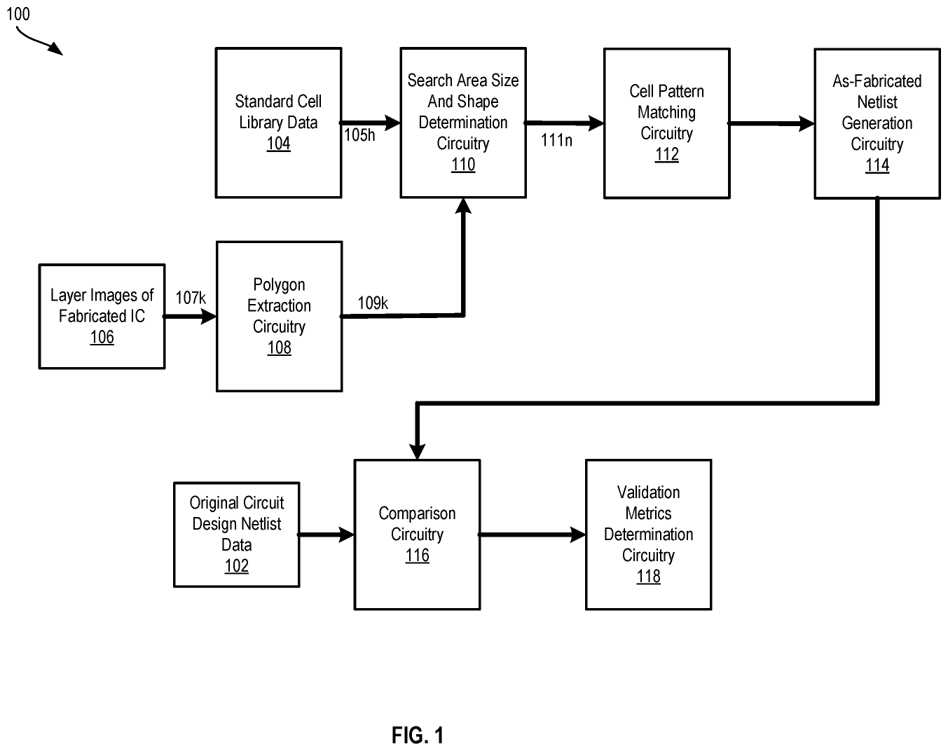

FIG. 1 illustrates a circuit design validation system 100 according to several embodiments of the present disclosure. As will be described below, the system 100 provides an automated mechanism to compare original design data to extracted features of a fabricated IC to determine validity metrics of the fabricated IC. The system 100 includes standard cell library (SCL) data 104 that generally defines a plurality of standard cell structures 105h used in a circuit design. As is known, the SCL 104 may be provided by a particular IC manufacturing foundry and is used as templates for circuit designers to design IC circuits. The SCL 104 provides, for each cell 105h in original circuit design data, a template of polygons that are associated with a given cell 105h. A “cell”, or “standard cell”, as used herein, represents a logic circuit element (e.g., AND, OR, NOT, NAND, NOR, etc.) and/or a collection of logic circuit elements (e.g., flip-flop circuits, registers, etc.). The “cell” as used herein may include the metal trace layout information (e.g., metal trace placement, input output placement (I/O), interconnect placement, etc.) and polysilicon layout information (e.g., gate placement, logic element placement, etc.) of a given cell design, and such metal layout information and polysilicon layout information may be formed on multiple layers of a circuit design. The original circuit design data generally includes information about each cell (“cell information”). Cell information may be represented as a plurality of data fields to specify information about the physical structure of the cell (e.g., electrical characteristics of the logic circuit element), the size and shape of the cell (e.g., physical size, e.g., x-y total size, physical location in 2D or 3D space within a design, etc.), and may also include unique identifying information of a cell (e.g., unique label, etc.), etc. The template of polygons are generally unique to each cell, and the polygons of a cell have a specified size, shape, and spatial orientation with respect to each other. The standard cell library data 104 may be formed using conventional and/or proprietary circuit design tools to generate circuit design data in conventional and/or proprietary formatting, for example, GSDII data, etc.

A collection of standard cells are used to design an entire IC, a standard cell may include information on a plurality of layers. Each layer typically includes a collection of metal traces (metal trace layer) associated with a plurality of cells, or a collection of polysilicon regions (polysilicon layer). Both metal traces and polysilicon regions are defined as polygons of a variety of shapes, as is well-known, and a collection of such polygons forms a standard cell. The circuit design data (e.g., GDSII data file, etc.) is typically used to fabricate the IC (including the plurality of layers of the IC) using the circuit design data. Once fabricated, the IC may be checked, on a layer-by-layer basis, to verify that the as-fabricated IC matches the original circuit design, as described below.

Accordingly, layer images of the fabricated IC 106 may be generated using conventional and/or proprietary delayering and imaging techniques of a fabricated IC, such as, for example, scanning electron microscopy (SEM) imaging techniques, etc. Each layer image may be generated as a separate image file, thus assuming k layers associated with the as-fabricated IC, the layer images may include k number of layer image files, denoted as 107k, which may include (1-i) polysilicon layers and (1-j) metal trace layers. These layers image files may be considered “raw” image files of the as-fabricated circuit design. As is known, IC fabrication generally generates polygons that have “rounded” corners and non-smooth edges, as opposed to the polygons used in standard cells for the original circuit design. Accordingly, the present disclosure also includes polygon extraction circuitry 108 generally configured to extract polygon information from each of the layer image files 107k and generate extracted layer image files 109k. Polygons in a layer image file 107k may be identified using known and/or proprietary polygon extraction techniques such as machine vision techniques, convolution neural network techniques, etc. Identified polygons and their respective positions within each extracted layer image file 109k may be formatted into a vectorized black-and-white image file, such that pixels associated with a polygon in the extracted image file are assigned a first bit value (e.g., bit value of 1, representing a white pixel) and areas within the extracted layer image file that are not associated with a polygon are assigned a second bit value (e.g., a bit value of 0, representing a black pixel for areas around one or more polygons). The extracted layer image files 109k include a plurality of extracted metal trace layer image files (1-j) and a plurality of extracted polysilicon image files (1-i), corresponding to the number of raw layer image files 107k.

The system 100 also includes search area size and shape determination circuitry 110 generally configured to determine a search area size of a given extracted image layer 109k. The search area size and shape may be based on, for example, the overall size and shape of a given standard cell to be searched within the extracted image layer, a largest cell type associated with a given as-designed layer, and/or other characteristics of a given image layer such as location and/or orientation of voltage rails (e.g., Vss, Vdd, etc.) within the extracted image of a metal trace layer, location and/or orientation of polysilicon formations within an extracted image layer of a polysilicon layer, etc. The shape of a search tile may include, for example, a rectangular strip, or “ribbon”, having a size and orientation of a given cell and/or collection of cells. Thus, each extracted image layer file 109k may include a plurality of “ribbons” 111n that are used to search for standard cells, as described below. It should be noted that the number of ribbons 111n does not necessarily need to be the same for each extracted image file 109k.

The system 100 also includes cell pattern matching circuitry 112 generally configured to determine a match between a cell template of the SCL and one or more cells associated with the extracted layer images 109k of the as-fabricated IC. In particular, the cell pattern matching circuitry 112 is configured to compare the pixel values of a standard cell against pixel values of a ribbon 111n to determine a score. In some embodiments, the standard cell may be compared to the ribbon at each pixel increment, as will be described below. The score may be determined, for example using a sum of squares difference, etc. and generally represents the number of pixel values that match between a given standard cell and a location along the ribbon.

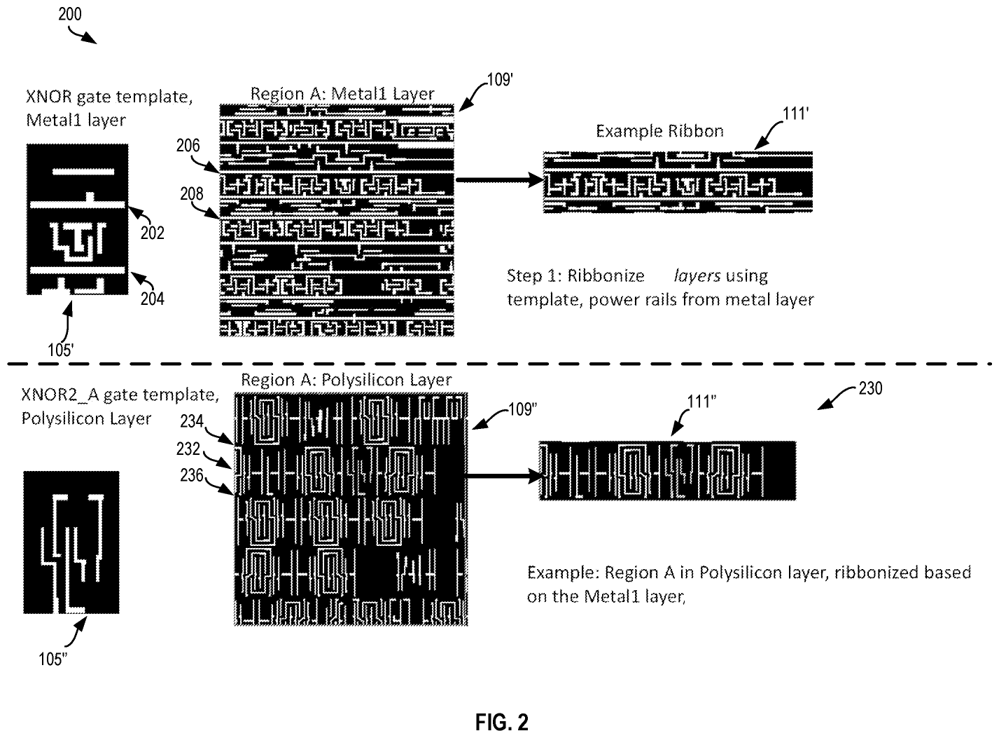

FIG. 2 illustrates operations of the search area size and shape determination circuitry 110 according to one example embodiment of the present disclosure. The top portion of FIG. 2, shown generally at 200, illustrates operations of the search area size and shape determination circuitry 110 with respect to a metal layer. The metal layer 200, by way of example, illustrates a standard cell template (image) of a metal layer of an XNOR gate 105′. The standard cell template 105′ includes a plurality of polygon shapes (white portions) arranged with respect to with a first voltage rail 202 and a second voltage rail 204. In this example, the voltage rails 202 and 204 are arranged horizontally and generally parallel to one another. An extracted metal image layer 109′ is illustrated having a plurality voltage rail traces, e.g., 206 and 208. The orientation of the illustrated extracted metal layer image 109′ is such that the voltage rails 206 and 208 are disposed horizontally.

Voltage rails, particularly in metal trace layers, are common features that are often used in circuit design layout to place a variety of standard cells with respect to voltage rails. Likewise, standard cells use voltage rails for placement orientation of various polygons of the cell. Thus, in this example embodiment, voltage rails 202 and 204 of the cell template layer 105′ are used as a “guide” to compare to the extracted metal layer image 109′. While voltage rails represent known common features of a metal layer of a standard cell template and thus, of an as-fabricated IC, voltage rails form a basis of comparison between the standard cell image 105′ and the extracted metal layer image 109′ that has a high probability of determining one or matches between various areas of the extracted metal layer image 109′ and the standard cell template image 105′. Of course, in other embodiments, other features of a standard cell template and an extracted layer image may be used as a comparison guide, and as a general matter, any features that are consistent and/or repetitive within a cell template may be used as a searching guide. Also, while both the rails 202/204 and 206/208 are arranged horizontally in this example, it should be understood that the image orientation of the extracted metal layer image 109′ or the standard cell template may be rotated (e.g., rotated 90 degrees) so that the voltage rails 202/204 and 206/208 are oriented in the same direction.

Accordingly, since both the standard cell 105′ and the extracted metal layer image 109′ have voltage rails arranged horizontally, search area size and shape determination circuitry 110 is configured to generate a ribbon 111′ of the extracted metal trace image layer 109′. The ribbon 111′ of this example includes the image information between rails 206 and 208, and also includes image information above (210) and below (212) the rails 206 and 208, respectively. The image information above (210) and below (212) the rails 206 and 208, respectively, is based an image size of the standard cell 105′. Thus, for example, assume that the standard cell 105′ is 50 pixels (x dimension) wide by 100 pixels tall (y dimension), and a distance between the rails 202 and 204 is 25 pixels, with 10 pixels below rail 204 and 15 pixels above rail 202. Thus, the ribbon 111′ is selected to be 100 pixels tall, and a distance between the rails 206 and 208 is 25 pixels, with 10 pixels below rail 208 and 15 pixels above rail 206. The width (x-dimension) of the ribbon 111′ may span the entire width of the extracted metal layer image 109′ (or some subset thereof). It should be noted that the extracted metal layer image 109′ and/or standard cell image 105′ may be scaled to match dimensions between respective voltage rail pairs. The search area size and shape determination circuitry 110 is also configured to generate additions ribbons (not shown) one for each voltage rail pair in the extracted metal layer image 109′, thus enabling a search of the entirety of the extracted metal layer image 109′.

The bottom portion of FIG. 2, shown generally at 230, illustrates operations of the search area size and shape determination circuitry 110 with respect to a polysilicon layer. The polysilicon layer 200, by way of example, illustrates a standard cell template (image) of a polysilicon layer of the XNOR gate 105″. The standard cell template 105″ includes a plurality of polygon shapes (white polygon portions). An extracted polysilicon image layer 109″ is illustrated having a plurality cells arranged horizontally (white polygons), 232, and each horizontal “strip” is separated by a space (dark regions) 234 and 236 represented an insulation region between each strip of polysilicon polygons.

For the polysilicon layer, insulating regions between strips of cells are often used in circuit design layout to place a variety of standard cells with respect to a given layer, and typically will span most or all of the width (or length) of a given polysilicon layer. Likewise, standard cells use these insulated regions for placement orientation of various polygons of the cell. Thus, in this example embodiment, insulation regions 234 and 236 of the cell template layer 105′ are used as a “guide” to compare to the extracted polysilicon layer image 109″ to the standard cell 105″. Also, while both the standard cell 105″ and the strips in the polysilicon layer image 109″ are arranged horizontally in this example, it should be understood that the image orientation of the extracted polysilicon layer image 109′ or the standard cell template 105″ may be rotated (e.g., rotated 90 degrees) so that the polygons are both are oriented in the same direction.

Accordingly, the search area size and shape determination circuitry 110 is configured to generate a ribbon 111″ of the extracted polysilicon image layer 109′. The ribbon 111″ of this example includes the image information between insulation regions 234 and 236, and is based an image size of the standard cell 105″. Thus, for example, assume that the standard cell 105″ is 50 pixels (x dimension) wide by 100 pixels tall (y dimension), the ribbon 111″ is selected to be 100 pixels tall. The width (x-dimension) of the ribbon 111″ may span the entire width of the extracted polysilicon layer image 109″ (or some subset thereof). It should be noted that the polysilicon layer image 109″ and/or standard cell image 105″ may be scaled to match dimensions between respective voltage rail pairs. The search area size and shape determination circuitry 110 is also configured to generate additions ribbons (not shown) one for each polygon strip in the extracted polysilicon layer image 109″, thus enabling a search of the entirety of the extracted polysilicon layer image 109″.

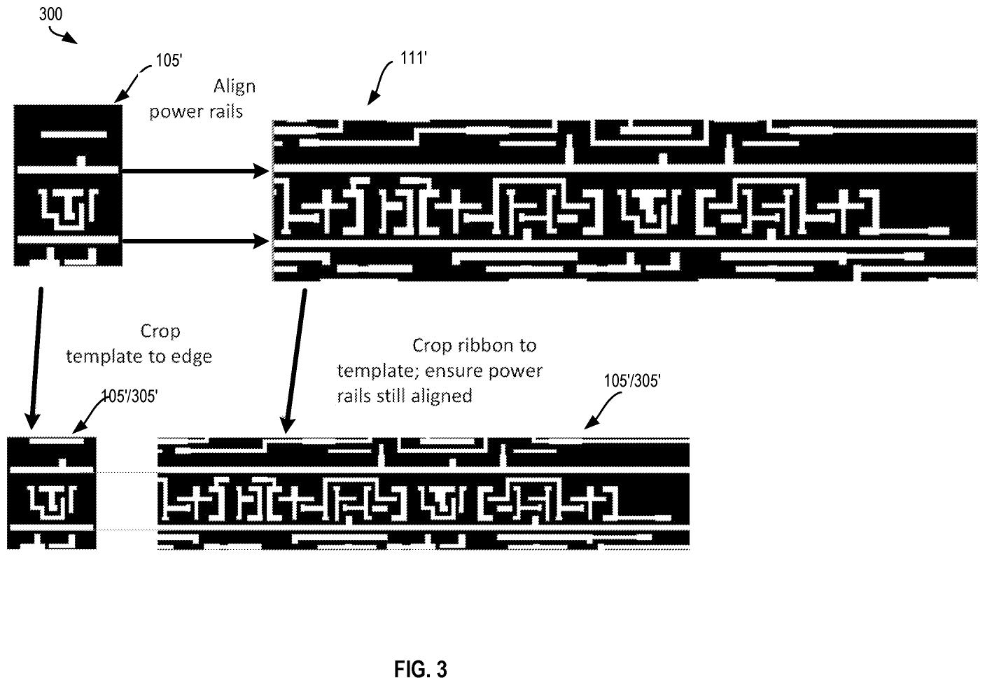

FIG. 3 illustrates additional example operations 300 of the search area size and shape determination circuitry 110 according to one embodiment of the present disclosure. In particular, FIG. 3 illustrates example resizing operations for the ribbon 111′ and/or standard cell 105′ of FIG. 2. In an initial step, the voltage rails 202/204 may be aligned (along the y axis) to the voltage rails 206/208. To avoid unnecessary searching, the standard cell 105′ and/or ribbon 111′ may be cropped in the y-dimension, to form and cropped standard cell 305′ and/or cropped ribbon 311′, so the cropped standard cell 305′ and cropped ribbon 311′ each have substantially the same number of pixels in the y-dimension.

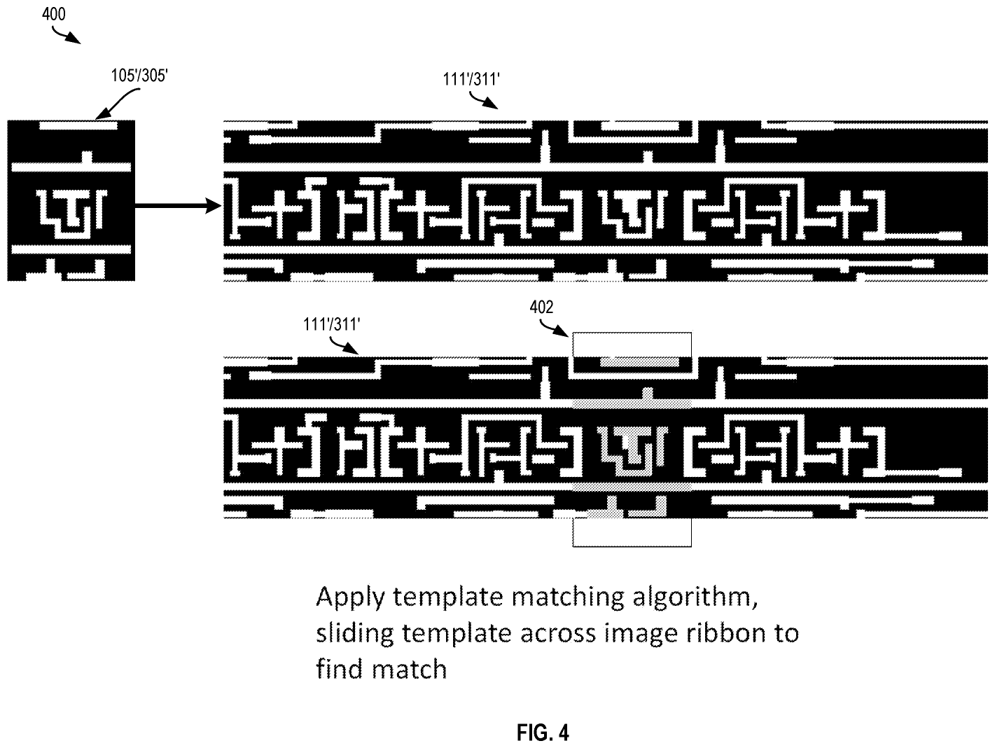

FIG. 4 illustrates example operations 400 of the cell pattern matching circuitry 112 according to one embodiment of the present disclosure. In particular, FIG. 4 illustrates example searching of for a match of the standard cell 105′ in the ribbon 111′ of FIG. 2. In this example, assume that the standard cell 105′/305′ and ribbon 111′/311′ have been cropped so that each are 85 pixels tall (y-dimension). Also assume that the standard cell 105′/305′ is 50 pixels wide (x-dimension) and that the ribbon 111′/311′ is 350 pixels wide (x-dimension). Searching the ribbon 111′/311′ for a pattern match with the standard cell 105′/305′ includes incrementally “sliding” the standard cell 105′/305′ along the ribbon 111′/311′, such that the rails 202/204 are coincident with rails 204 and 206, and determining the number of matching pixels at that incremental location along the ribbon 111′/311′.

Since the standard cell 105′/305′ is 50 pixels wide, the search may start by aligning each column of pixels in the standard cell 105′/305′ with the ribbon 111′/311′, starting at the left-most pixel. In other words, the search may start by aligning the pixels in the first column of the standard cell 105′/305′ with pixels in the first column of the ribbon 111′/311′, aligning the pixels in the second column of the standard cell 105′/305′ with the pixels in the second column of the ribbon 111′/311′, and so on, until all the pixels of the standard cell 105′/305′ are aligned with the ribbon 111′/311′, up to column 50. The cell pattern matching circuitry 112 is also configured to determine the number of pixels that match, at each pixel location, between the standard cell 105′/305′ and the portion of ribbon 111′/311′ being compared to. The number of matching pixels may be used to generate a matching score for that pixel location (i.e., pixel column 1). The matching score may be derived using, for example, least squares difference analysis. The operations continue by incrementing to the next pixel column (column 2) of the ribbon 111′/311′ and aligning the pixels in the first column of the standard cell 105′/305′ with pixels in the second column of the ribbon 111′/311′, aligning the pixels in the second column of the standard cell 105′/305′ with the pixels in the third column of the ribbon 111′/311′, and so on, until all the pixels of the standard cell 105′/305′ are aligned with the ribbon 111′/311′, up to column 51. This process is continued so that the standard cell 105′/305′ is compared to the entirety of the ribbon, and a matching score is generated at each incremental pixel column location. It should be noted that since the voltage rails 202/204 and 206/208 were aligned in previous operations, the rails 202/204 and 206/208 will remain coincident while “sliding” the standard cell 105′/305′ along the ribbon 111′/311′.

Operations of the cell pattern matching circuitry 112 also may include “mirroring” the standard cell 105′/305′ (i.e., generating a mirror image of the standard cell 105′/305′) and performing the operations of aligning, increment and generating a matching score described above using the mirror image of the standard cell 105′/305′. In addition, operations of the cell pattern matching circuitry 112 also may include “flipping” the standard cell 105′/305′ (i.e., rotating the standard cell 105′/305′ 180 degrees) and performing the operations of aligning, increment and generating a matching score described above using the “flipped” standard cell 105′/305′. In addition, operations of the cell pattern matching circuitry 112 also may include “flipping and mirroring” the standard cell 105′/305′ (i.e., rotating the standard cell 105′/305′ 180 degrees and generating a mirror image of the flipped image) and performing the operations of aligning, increment and generating a matching score described above using the “flipped and mirrored” standard cell 105′/305′.

Once the various orientations of the standard cell 105′/305′ have been compared to the ribbon 111′/311′, as described above, the matching score with the highest value (indicating the largest number of matching pixel values) may be selected as a placement candidate for that cell. The placement candidate includes the x and y locations along the ribbon 111′/311′ that represent the highest matching score for that given standard cell 105′/305′, as illustrated at location 402. Alternatively, matching scores that exceed a preselected threshold (e.g., 95% confidence interval, etc.) may be selected as placement candidates for that cell.

The foregoing operations of FIGS. 2-4 may be repeated for the polysilicon layer 230 (illustrated in FIG. 2). The foregoing example operations of FIGS. 2-4 may be repeated for each ribbon of a layer image, and for each layer image. In that regard, the cell pattern matching circuitry 112 may also be configured to compare the placement candidate(s) of the metal layer with placement candidate(s) of the polysilicon layer (for example by comparing each of the matching scores for these layers). If the matching scores between different layers are substantially equal, this may indicate a high confidence that the placement candidate is accurate. However, if the matching scores between different layers for a given standard cell are substantially unequal (i.e., conflict between layers), this may indicate a low confidence that the placement candidate is accurate. Once each layer image has been searched for a given standard cell 105′/305′ (or 105″), the foregoing example operations of FIGS. 2-4 may be repeated for other standard cell(s) that may be included in the circuit design.

The cell pattern matching circuitry 112 may also be configured to determine a “best” placement candidate for a given location. For example, the cell pattern matching circuitry may select a “larger” cell template over a “smaller” cell template when the “larger” and “smaller” cell templates each have substantially the same matching score.

The foregoing examples of FIGS. 2-4 have assumed horizontal alignment and thus the ribbon 111′/311′ is a horizontally aligned ribbon. It should be understood that the foregoing examples of FIGS. 2-4 may be used for “vertically” aligned operations. In addition, reference to “sliding” the standard cell over the ribbon is used herein as a metaphor for the comparison operations to compare the respective pixel values of the standard cell to the respective pixel values of ribbon and incrementing that comparison by one pixel column (or pixel row) for the next comparison of the pixels of the standard cell to the ribbon, and so on.

The following pseudocode represents operations of the search area size and shape determination circuitry 110 and the cell pattern matching circuitry 112.

```
// Preprocess Search Layers into Image Ribbons
get image for specified search layer
  determine pixel height h_r of horizontal rows of standard cells
  determine starting point y_0 // ensures standard cells are aligned
  let k = ceiling(image_height/h_r)
  foreach i in range(0,k):
    cut stitched image at y positions [h_r*i + y_0, h_r*(i+1) + y_0] //
ribbon creation, a single row of standard cells
    execute search with ribbon tile (Line 21)
  <end foreach i>
// Execute Search
foreach standard cell in standard cell library
  create template image of specified search layer // height = h_r
    if ribbon is oriented downward relative to template:
      flip template image vertically
    <end if>
    determine y_top, y_bottom, x_left, x_right // remove black
    border −1px
    crop template to remove y_top and y_bottom pixels from top and
    bottom
    crop template to remove x_left and x_right pixels from sides
    crop ribbon to remove y_top and y_bottom pixels from top and
    bottom
    foreach x position in ribbon:
      foreach valid orientation of template image // 2: original, mirrored
        apply OpenCV template matching algorithm // sum of square
        diffs
        normalize scores 0.0-1.0 // 1.0 perfect match
        zero out low scores // less than configuration threshold
        determine local maxima mask
        foreach x position in resulting vector:
          if mask[x] != 0:
            if orientation == original:
              X = location(x) − x_left
            else if orientation == mirrored:
              X = location(x) − x_right
            <end if>
            add X, orientation, ribbon, score as placement candidate
          <end if>
        <end foreach x position in vector>
      <end foreach orientation>
    <end foreach x position in ribbon>
<end foreach standard cell>
//Determine placements
foreach placement candidate:
  check for conflicts on all search layers // overlaps other candidates
  if no conflicts:
    add candidate, orientation as placement
  else:
    add candidate, orientation with greatest score as placement
  <end if>
<end foreach placement candidate>
commit placements as cell instances
```

The system 100 of FIG. 1 also includes as-fabricated netlist generation circuitry 114 generally configured to generate a netlist of the as-fabricated circuit design, based on the matched cells determined by the cell pattern matching circuitry 112, described above. The netlist generated by the netlist generation circuitry 114 may be formatted in a standard and/or propriety file structure such as a Verilog Hardware Description Language (HDL) file, etc. The netlist may include, for example, cell type data, cell connection data, etc. Additional information may be captured in other file types, for example, cell placement (e.g., x-y placement) data, cell orientation data port location and layer data, etc. The system 100 also includes comparison circuitry 116 generally configured to compare the as fabricated netlist to the original circuit design netlists data, to determine, for example, if there are errors and/or mismatches in the as-fabricated IC. In this manner, the validation of the as-fabricated IC may be verified against the original circuit design data. To that end, the system 100 may also include validation metrics determination circuitry 118 to determine one or more validation metrics concerning the as-fabricated IC. Validation metrics may include, for example, erroneous placement of one or more cells, erroneous omission of cell structure, and/or erroneous port placement of one or more cells, etc. In addition, validation metrics may also include, determining equivalence of the as-fabricated recovered netlist to the original netlist, logical equivalence checks, verification testbench model checks, graph isomorphism checks, etc.

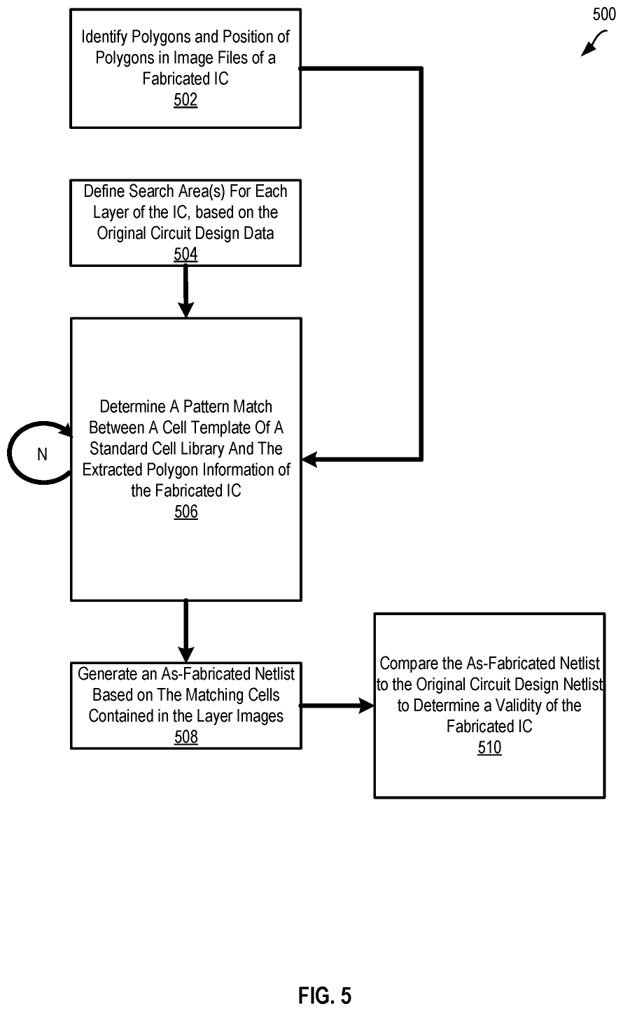

FIG. 5 illustrates a flowchart 500 of operations for circuit design validation according to one embodiment of the present disclosure. Operations of this embodiment include extract polygon information contained in one or more layer images of a fabricated integrated circuit (IC) 502. Operations of this embodiment also include defining one or more search area(s) of a given layer of an IC, based on original circuit design data of the IC 504. Operations also include determining a pattern match between a cell template of a standard cell library and the extracted polygon information of the fabricated IC 506. The operations 506 may be repeated to define templates for each of N cell types associated with the IC.

Operations also include generating an as-fabricated netlist based on the matching cells contained within the layer images 508. Operations also include comparing the as-fabricated netlist to the original circuit design netlist to determine a validity of the fabricated IC 510.

While FIG. 5 illustrates various operations according to one or more embodiments, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

Any of the operations described herein may be implemented in a system that includes one or more non-transitory storage devices having stored therein, individually or in combination, instructions that when executed by circuitry perform the operations. “Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device. Also, it is intended that operations described herein may be distributed across a plurality of physical devices, such as processing structures at more than one different physical location.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment, Thus, appearances of the phrases “in one embodiment” or “in an embodiment” in various places throughout this specification are not necessarily all referring to the same embodiment. Furthermore, the particular features, structures, Or characteristics may be combined in any suitable manner in one or more embodiments.

What is claimed:

1. A circuit design validation system, comprising:
polygon extraction circuitry to determine, based on layer images of a fabricated integrated circuit (IC), a plurality of polygons associated with a layer of the fabricated IC; and
cell pattern matching circuitry to search the polygons defined within a layer image of the fabricated IC to determine a match between a cell template of a standard cell library and the plurality of polygons defined within the layer image of the fabricated IC.

2. The system of claim 1, further comprising size and shape determination to define a search area and size of the layer image of the fabricated IC, wherein the size and shape of the search area are based on a given said cell template associated with original circuit design data.

3. The system of claim 1, wherein the cell template includes a plurality of polygons that define a particular cell type.

4. The system of claim 1, further comprising netlist generation circuitry to generate an as-fabricated netlist based on matching cells between the standard cell library and the layer images.

5. The system of claim 4, further comprising comparison circuitry to compare an original design netlist with the as-fabricated netlist to determine one or more validity metrics of the fabricated IC.

6. The system of claim 5, wherein the one or more validity metrics include erroneous placement of one or more cells, erroneous omission of cell structure, and/or erroneous port placement of one or more cells.

7. A circuit design validation method, comprising:
extracting polygons associated with one or more layers of a fabricated integrated circuit (IC), based on layer images of the fabricated IC; and
searching the layer images of the fabricated IC to determine a match between polygons associated with the fabricated IC and a cell template information of a standard cell library.

8. The method of claim 7, further comprising defining a tile search area and size of the layer image of the fabricated IC, wherein a tile size and shape are based on a given cell type associated with original circuit design data.

9. The method of claim 7, wherein the cell template includes a plurality of polygons that define a particular cell type.

10. The method of claim 7, further comprising generating an as-fabricated netlist based on matching cells between the standard cell library and the layer images.

11. The method of claim 10, further comprising comparing an original circuit design netlist with the as-fabricated netlist to determine one or more validity metrics of the fabricated IC.

12. The method of claim 11, wherein the one or more validity metrics include erroneous placement of one or more cells, erroneous omission of cell structure, and/or erroneous port placement of one or more cells.

13. A non-transitory storage device that includes machine-readable instructions that, when executed by one or more processors, cause the one or more processors to perform operations, comprising:
extract polygons associated with one or more layers of a fabricated integrated circuit (IC), based on layer images of the fabricated IC; and
search the layer images of the fabricated IC to determine a match between polygons associated with the fabricated IC and a cell template information of a standard cell library.

14. The non-transitory storage device of claim 13, wherein the machine-readable instructions that, when executed by one or more processors, cause the one or more processors to perform operations, comprising:
define a tile search area and size of the layer image of the fabricated IC, wherein a tile size and shape are based on a given cell type associated with original circuit design data.

15. The non-transitory storage device of claim 13, wherein the cell template includes a plurality of polygons that define a particular cell type.

16. The non-transitory storage device of claim 13, wherein the machine-readable instructions that, when executed by one or more processors, cause the one or more processors to perform operations, comprising:
generate an as-fabricated netlist based on matching cells between the standard cell library and the layer images.

17. The non-transitory storage device of claim 16, wherein the machine-readable instructions that, when executed by one or more processors, cause the one or more processors to perform operations, comprising:
compare an original circuit design netlist with the as-fabricated netlist to determine one or more validity metrics of the fabricated IC.

18. The non-transitory storage device of claim 17, wherein the one or more validity metrics include erroneous placement of one or more cells, erroneous omission of cell structure, and/or erroneous port placement of one or more cells.
